(19) United States
(12) Patent Application Publication
(10) Pub. No.: US 2025/0371405 A1
(43) Pub. Date: Dec. 4, 2025

(54) QUANTUM CONTROLLER PROGRAM LOADING

(71) Applicant: Quantum Machines, Tel Aviv (IL)

(72) Inventors: Avishai Ziv, Tel Aviv (IL); Ori Weber, Tel Aviv (IL); Yaniv Bar Maimon, Tel Aviv (IL); Oded Wertheim, Tel Aviv (IL); Yonatan Cohen, Tel Aviv (IL); Nissim Ofek, Tel Aviv (IL); Itamar Sivan, Tel Aviv (IL)

(21) Appl. No.: 18/676,042

(22) Filed: May 28, 2024

(51) Int. Cl. G06N 10/80; G06F 9/445

(52) U.S. Cl. CPC G06N 10/80; G06F 9/445

(57) ABSTRACT

Disclosed herein is a new system and method for loading quantum processor programs. Pulse processors are programmed, in real-time, according to a low-level instruction set to produce microwave pulses that manipulate the states in a quantum processor. The nature of qubits in the quantum processor causes quantum hardware characteristics to drift over time. These qubits undergo small physical changes that may damage the accuracy of the quantum gates, typically due to variation of temperature, or energy in the quantum hardware. This new system and method for loading quantum processor programs enables qubit calibration and the adjustment of the quantum hardware in real-time according to immediate feedback from one program to another.

### BACKGROUND

Limitations and disadvantages of conventional methods and systems for program loading will become apparent to one of skill in the art, through comparison of such approaches with some aspects of the present method and system set forth in the remainder of this disclosure with reference to the drawings.

### BRIEF SUMMARY

Methods and systems are provided for quantum controller program loading, substantially as illustrated by and/or described in connection with at least one of the figures, as set forth more completely in the claims.

### BRIEF DESCRIPTION OF THE DRAWINGS

FIG. 1 illustrates an example quantum controller programming a quantum processor in accordance with various example implementations of this disclosure.

FIG. 2 illustrates an example of a calibration graph, in accordance with various example implementations of this disclosure.

FIG. 3 illustrates an example quantum controller application for reducing program loading overhead, in accordance with various example implementations of this disclosure.

FIG. 4 illustrates an example quantum controller application for streaming data to a quantum program for fast classical-quantum iterations, in accordance with various example implementations of this disclosure.

FIG. 5 illustrates an example quantum controller application for extending the effective available memory of the pulse processor, in accordance with various example implementations of this disclosure.

FIG. 6 illustrates an example system in a system for quantum program loading, in accordance with various example implementations of this disclosure.

FIGS. 7A, 7B and 7C illustrate an example of copying a quantum program, in accordance with various example implementations of this disclosure.

FIG. 8 illustrates an example of using a look-up table for parametric programs, in accordance with various example implementations of this disclosure.

FIG. 9 illustrates an example of using a look-up table to stream input items to running programs, in accordance with various example implementations of this disclosure.

### DETAILED DESCRIPTION

A classical computer executes a program, via a central processing unit (CPU), by iterating over a set of instructions designated to operate the arithmetic and logical units of the computational system. A classical computer comprises a memory unit for storing the program that the CPU will execute.

In a quantum computer, the program is a set of baseband or microwave pulses which set/program the logical quantum gates that comprise the quantum circuit. The pulses may be parametric or generated on-the-fly, hence the program may comprise classical computation and data acquisition logic. The program typically comprises a readout operation that results in an inbound pulse carrying over information of the qubit state.

Typically, the pulses are sent from (and received by) a quantum controller. The quantum controller is a classical compute system that is able to execute programs that execute the qubits manipulation and readout. Thus, the quantum processor may be programmed in real-time. The programs may also contain classical control flows. The quantum controller may dynamically compute various states and variables and provide real-time decision making to determine which pulses to play to the quantum element, according to the qubits states during the program run.

A quantum algorithm is typically comprised of iterations between classical and quantum computation. The classical computation may be performed as part of the program or by a classical computer, using a CPU, GPU and additional accelerators. Each iteration utilizes one or more quantum programs. The programs or their parameters are typically set according to the calculations done on the results of previous iterations.

A quantum program is compiled into a set of microwave pulses which change the states of the quantum bits (qubits), or trigger a readout operation that results in an inbound pulse carrying over information of the qubit state. The qubit state provides a solution for a problem that the quantum algorithm is intended to solve.

Typically, the microwave pulses are sent from (and received by) a quantum controller. The quantum controller is a classical compute system that is able to execute programs of pulses that represents the qubit manipulation program. Thus, the quantum processor may be programmed in real-time. The programs may also contain classical control flow. The quantum controller may dynamically compute various states and variables and provide real-time decision making to determine which pulses to play to the quantum element, according to the qubits states during the program run.

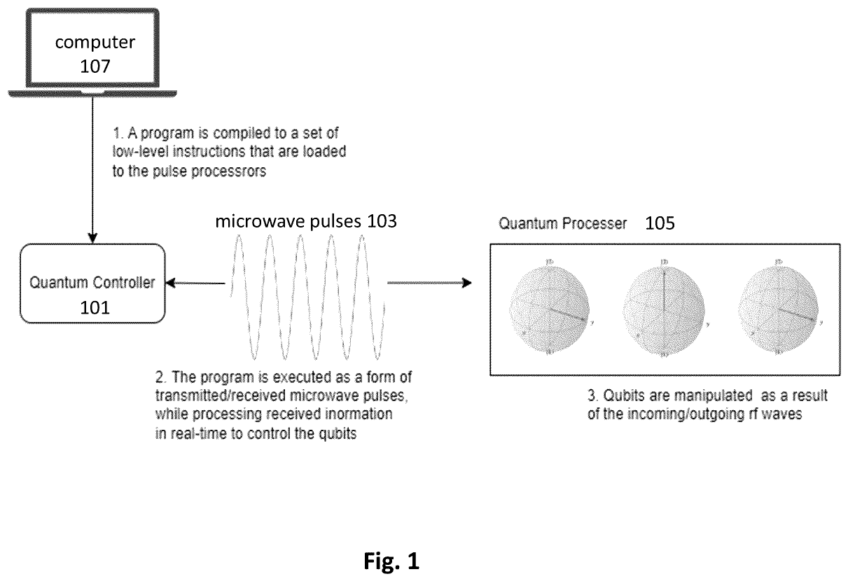

FIG. 1 illustrates an example quantum controller 101 programming a quantum processor 105 in accordance with various example implementations of this disclosure. A typical quantum controller 101 comprises a set of microprocessors, numerous RF elements, arithmetic/logical computation units, a feedback system, digital filters, etc. The microprocessors are also known as pulse-processors and may run on an FPGA, an ASIC, a classical computer, or any other medium. The pulse processors themselves are programmed 107 with a low-level instruction set to produce the required microwave pulses 103, as can be seen in FIG. 1.

The nature of the qubits causes their hardware characteristics to drift over time. The qubits undergo small physical changes that can damage the accuracy of the quantum gates, typically due to variation of temperature, or energy in the quantum hardware. This may be solved by constantly running qubit calibration programs to adjust the hardware to the desired state, such that the state may be manipulated and thus transformed to be as accurate as possible.

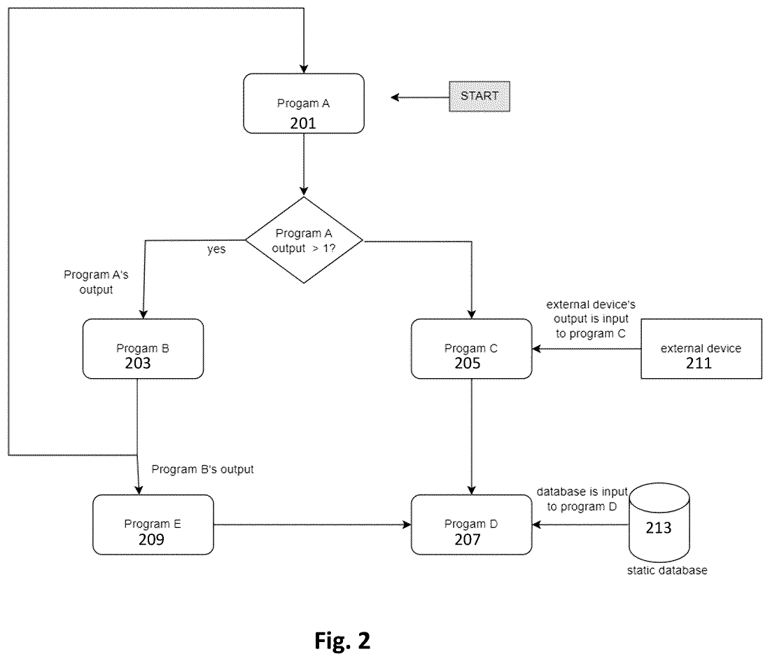

FIG. 2 illustrates an example of a calibration graph, in accordance with various example implementations of this disclosure. A general approach to qubit calibration is to run a series of programs 201, 203, 205, 207 and 209 sorted as a graph (‘calibration graph’). The series of programs 201, 203, 205, 207 and 209 are typically scheduled to be executed with input parameters. These parameters may be acquired by a previous program in the graph, streamed from an external device 211, and/or obtained from a static database 213. The graph branches to other programs based on the output.

The calibration graph depicted in FIG. 2 is small, for the sake of illustration. However, actual calibration graphs may comprise a significant amount of nodes (programs). These programs may require fast branching between pre-compiled programs, as well as retrieving input parameters to those programs from various sources (e.g., other programs' output, external devices or static database). The output of some programs may be processed by an external classical processor or a graphical processor (i.e., outside of the quantum controller) and then streamed back into the quantum controller to the next program in the graph. All of this must be done at a relatively high speed in order to allow tracking of the parameters drift and maximize the quantum computer utilization.

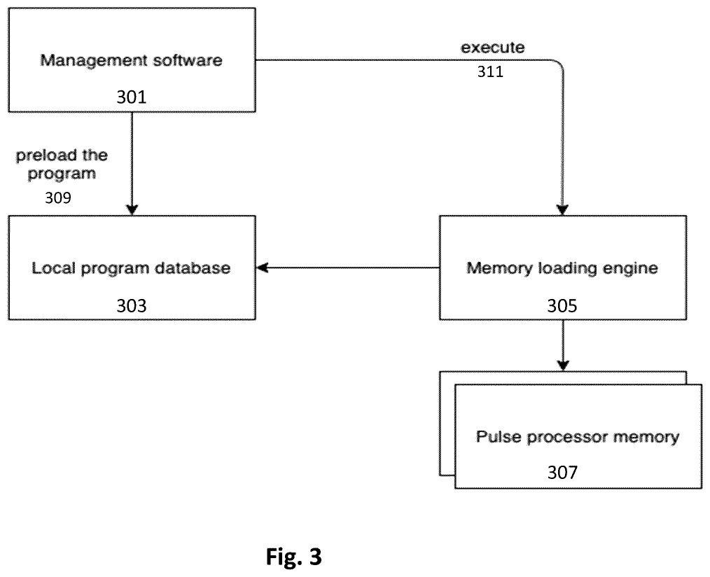

FIG. 3 illustrates an example quantum controller application for reducing program loading overhead, in accordance with various example implementations of this disclosure. To reduce the calibration time, a pulse processor program may be pre-loaded 309, from a management software, to a local cache or database 303. If the program is executed on multiple devices, each device may use a corresponding local database to ensure fast loading.

Because quantum computers are a scarce resource, there is value in maximizing their utilization. As properties of a quantum processor may drift over time there is value in reducing the calibration time.

Upon program execution 311, a hardware offload mechanism 305 may be used to copy the pulse processor program to the pulse processor memory 307. Copying the pulse processor program may be performed by executing a set of memory-copy routines and register write routines. If the pulse processor program uses parameters that are only provided upon execution, memory-copy and/or register-copy routines may be used to update the relevant parameters.

A dedicated digital block (e.g., FPGA or ASIC) may be combined with software to enable the managing, loading, and programming of the quantum controller in a way that will speed up the program loading, thereby speeding up the execution of such graphs significantly. This provides an operating system building block for a quantum controller.

For a quantum computer cluster that is available to many users through cloud or data center usage, an important metric for each quantum computer may the program utilization duty cycle. The program utilization duty cycle is the actual percentage of actual user usage. For example, assuming that calibration flows take X amount of time on average and that the dedicated software management unit consume Y amount of average, then the overall utilization is Z/(X+Y+Z) whereas Z is the user utilization. An ideal utilization requires X,Y<<Z (X and Y much smaller than Z).

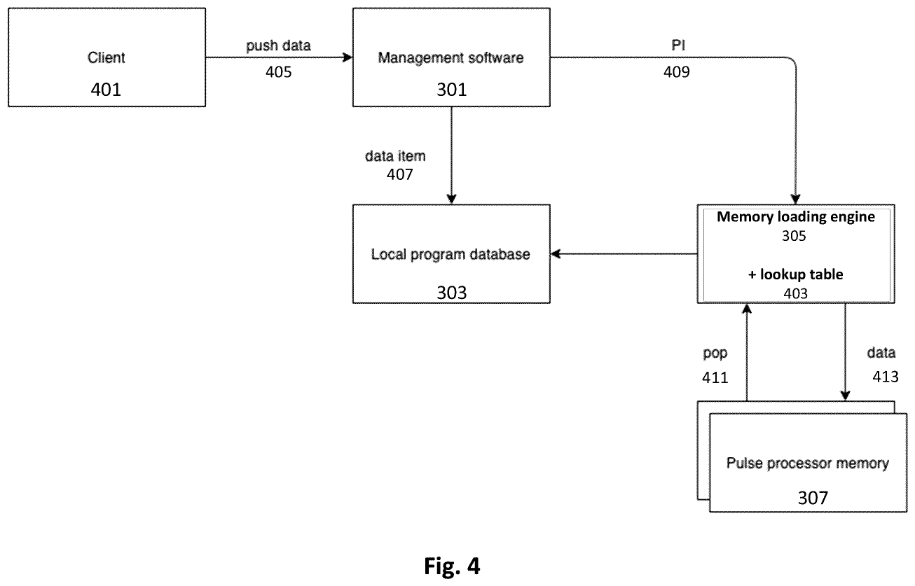

FIG. 4 illustrates an example quantum controller application for streaming data to a quantum program for fast classical-quantum iterations, in accordance with various example implementations of this disclosure.

A common case for quantum computation is a set of measurements of a pulse sequence or a parametric quantum circuit. A program, ready to execute, may be loaded according to a given set of pulses or parameters. The pulses or parameters may be streamed 405 from a user's computer 401. The streamed data may be calculated independently from previous results. For example, streamed data 405 may be calculated when running different sequences of random pulses or based on previous results. This may enable iterative classical-quantum hybrid algorithms. This method may be used to fetch different data elements 413 in the program, such as waveforms, variables, or integration weights.

A program may be executed with input streams memory allocated in the device DDR. Upon a user write to the input stream, the data 407 may be written to the DDR 103 by the management software 101, and a producer index (PI) 409 may be updated in a matching memory transaction descriptor in the look-up table (LUT) 403.

When the quantum program is set to pull a new data element 413, the memory copy routine may be executed 411 to copy the data 413 based on a consumer index (CI), and the CI may be updated. The program may be blocked during the fetch. Alternatively, the program may continue executing while the data 413 is copied. When there is no new data to read (i.e., CI=PI), the program may either pause or proceed with the previous data.

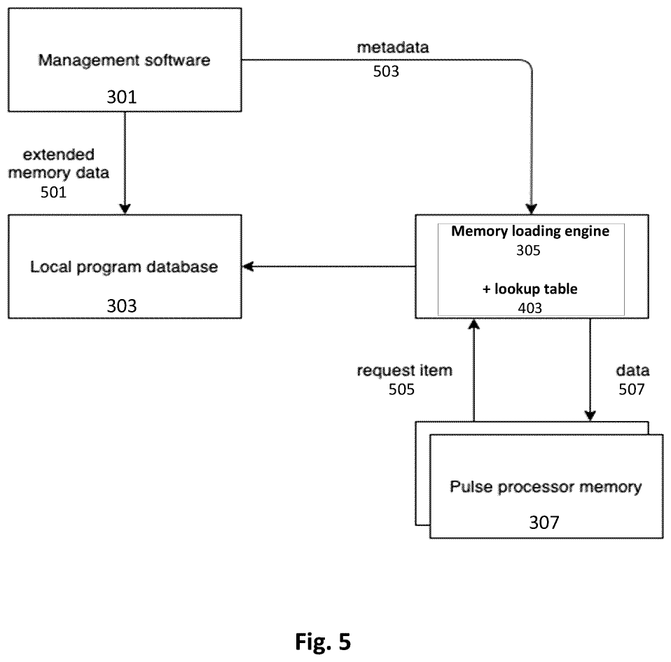

FIG. 5 illustrates an example quantum controller application for extending the effective available memory of the pulse processor, in accordance with various example implementations of this disclosure. The effective available memory may be extended by on-the-fly rapid data loading from an external memory.

A pulse processor may have a limited amount of direct memory 307 available for the quantum program. The memory 307 may hold, for example, program variables, parameters or waveforms. To overcome the memory size limit, a method for a rapid data loading is used, allowing the program flow to select the desired data 301 to load from the external RAM to the local memory 303.

When a program is loaded, a memory region may be allocated for the program in the device extended memory 303. For each data element 501 loaded into the extended memory 303, a memory copy transaction entry metadata 503 may be prepared in the LUT 403.

Upon a load request 505 from the program, the memory transaction may be executed for the desired data element 507. The data element 507 to be loaded from the external memory may be statically set in the program flow or dynamically decided during the program execution, for example, based on a measurement result. During the data load, the program may be blocked during the fetch, or the program may continue executing while the data is copied.

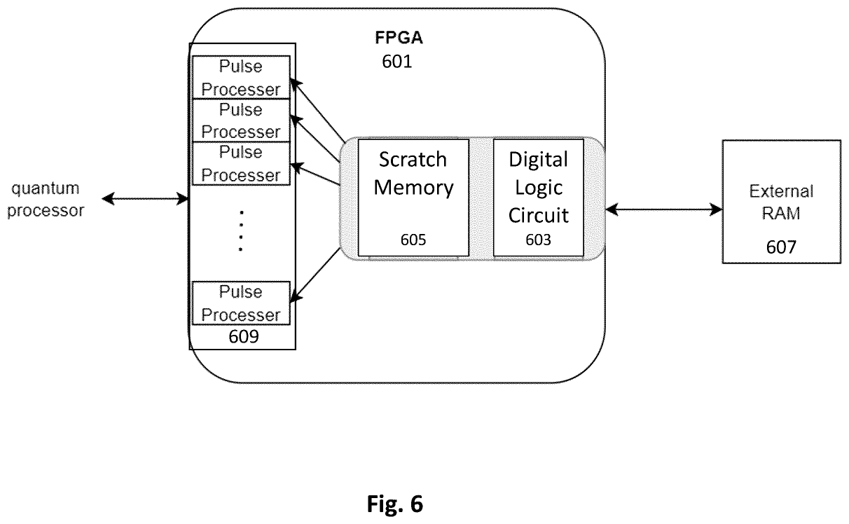

FIG. 6 illustrates an example system in a system for quantum program loading, in accordance with various example implementations of this disclosure. The hardware block 601 contains three modules—a digital logic circuit 603, a scratch memory 605 and a control unit responsible for timing the access to the digital logic circuit 603, scratch memory 605 and external memory 607, as well as managing external requests to these resources. The digital logic circuit 603 may comprise a look-up-table (LUT). This digital module 601 is connected to an external RAM (e.g. DDR and HBM) 607 from one side, and to memory for pulse processors 609 on the other side. The various pulse processors 609 may be programmed in parallel.

The quantum programs are pre-compiled before starting to run the graph of programs and are then loaded to the external RAM 607 via software. Each program may comprise program data (example waveforms, pulse processor instructions and commands) and program loading elements. Each memory copy element may either be a memory-copy routine or a register-write routine.

A memory-copy routine comprises a source address, a destination address, a transaction length and a transaction type. The source address is where to copy data from (e.g., address in the DDR). The destination address is where to copy the data to (e.g., which pulse-processor memory region). Typically, the source will point to a program data element and the destination to an address space in the processor where the program element needs to be written to.

A register-write routine is a list of hardware register initialization sequences to be executed before the program starts.

A memory-copy routine and a register-write routine perform a similar action of a memory copy. However, in a memory-copy the data to be written is prepared in a source memory while for a register write, the data is set as part of the routine.

The LUT 603 contains numerous rows. Each row represents a memory transaction performed by the program loading hardware component, from the external RAM, and into the pulse processors' memory. Each row contains the following columns:
a. Source address: address of a cyclic buffer in the external RAM 607, or a memory mapped region in an external device (where to copy the data from)
b. Destination address: where to copy the data to. Can be either the pulse processors' memories, or the scratch memory (e.g., meta programming, where the memory containing the descriptor is holding a descriptor to program itself).
c. Length: memory transaction length (number of bytes to copy)
d. Number of items—the number of items (each item has a length which is specified as ‘length’ above) in the cyclic buffer. For example if the item length is 4, and the number of items is 10, the buffer will be of size 40 bytes.
e. CI—Consumer Index, which serves as a read pointer of the buffer described above.
f. PI—Producer Index, which serves as a write pointer of the buffer described above.
g. Transaction Type: whether it is a memory-copy or a register-write programming descriptor.

The scratch memory can store the elements of information and the digital logic circuitry traverses through this list of elements in order to copy the quantum program to the pulse processors' memories.

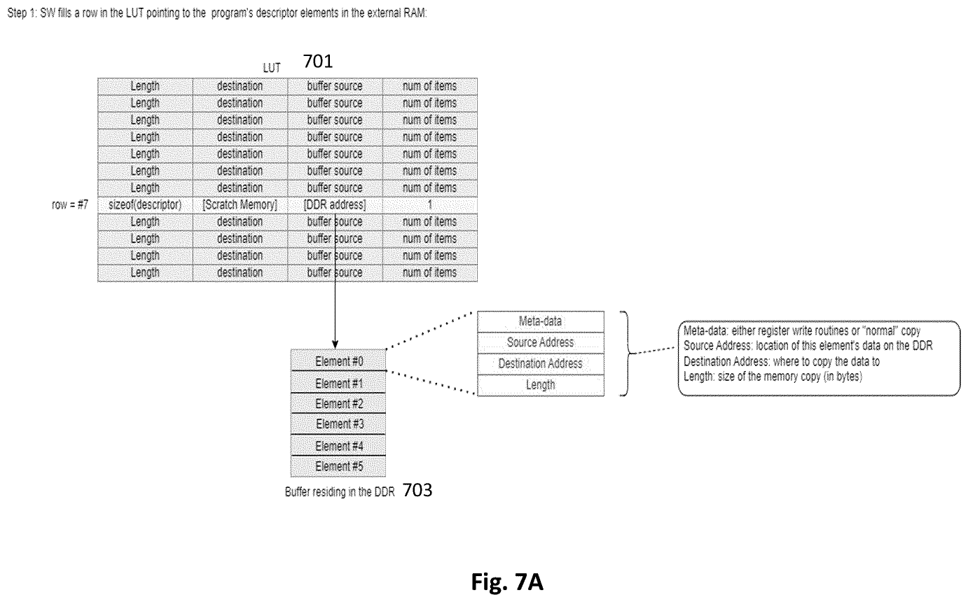

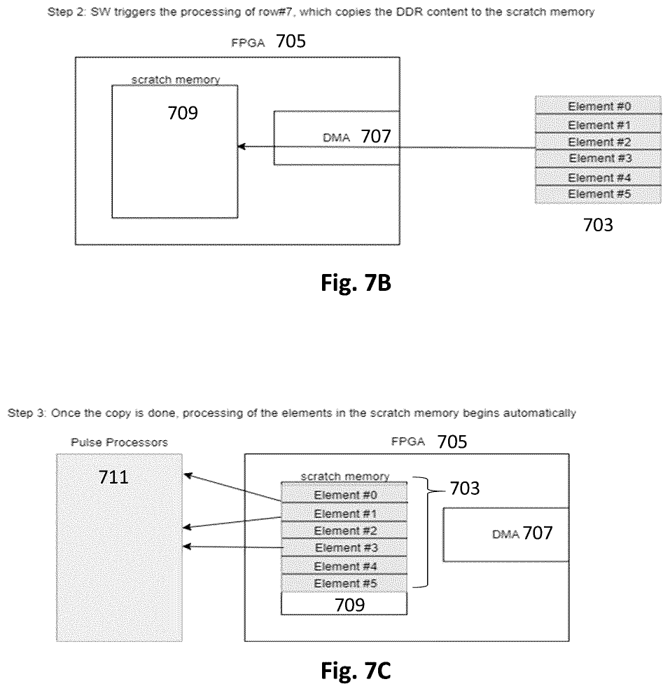

FIGS. 7A, 7B and 7C illustrate an example of copying a quantum program, in accordance with various example implementations of this disclosure. FIGS. 7A, 7B and 7C use the LUT and scratch memory to load a program.

One row in the LUT 701 represents a quantum program. The program itself is initially stored in a DDR memory 703, and represented as a scatter-gather element list. Once software triggers the program loading, it triggers a processing of a specific row in the LUT 701 (in the example illustrated in FIG. 7A, row #7).

As shown in FIG. 7B, the FPGA 705 then copies (via DMA 707) X bytes (where X is specified in the ‘length’ column) from the buffer 703 in the DDR (specified in the ‘buffer source’ column) to the scratch memory 709 (specified in the ‘destination’ column). The ‘number of items’ column is ‘1’, since in this specific case, the buffer is copied as a single, whole item.

Note that each element has its own source/destination addresses and length specifier. The scratch memory 709 serves as another level of indirection for the copy, and to allow another level of flexibility. Note that there is no limitation on the descriptor size (in the DDR), since one of the elements in the scatter-gather list can be repurposed to copy the rest of the elements from the DDR to the scratch memory 709. In a way, the program loading hardware component is programming its own scratch memory 709 if the descriptor is larger than the memory size, thus allowing the FPGA 705 to process programs which are larger than the size of the FPGA resources

As shown in FIG. 7C, the trigger to process the row in the LUT can either come from software, or from any of the pulse processors 711 themselves, or from an external device (via a designated interface), thus being able to seamlessly load programs “on the fly.” This allows the quantum controller to execute complex program graphs, as described in reference to FIG. 2. The user can pre-load programs to the LUT (each program in a different row) and select which program to load next based on inputs acquired in real-time, in minimal latency and without software intervention.

The aforementioned behavior in FIG. 7A-7C enables a single program to be compiled and reused with different parameters, thus allowing an efficient realization of the practical use-cases of quantum computing, such as calibration graphs, training of neural networks, etc.

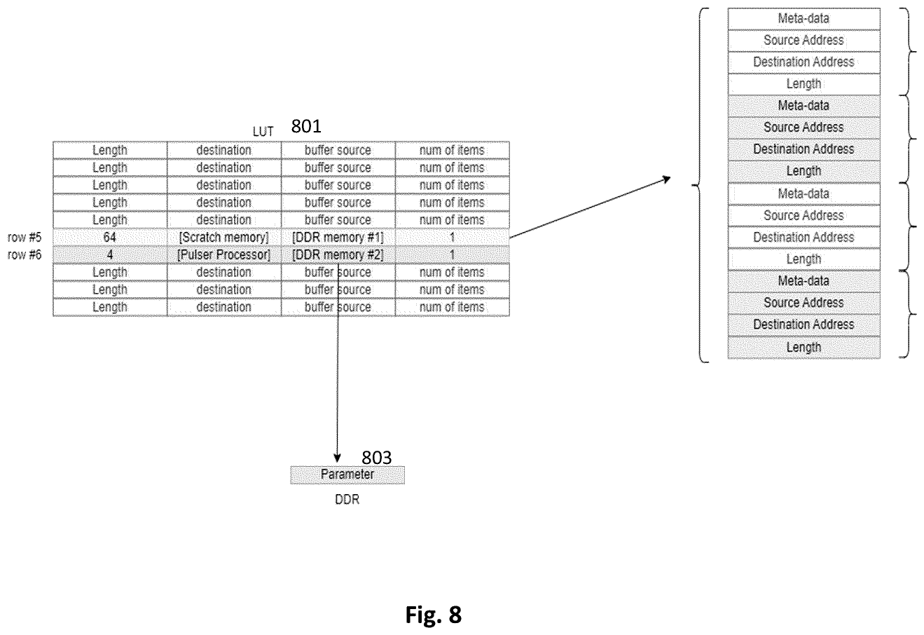

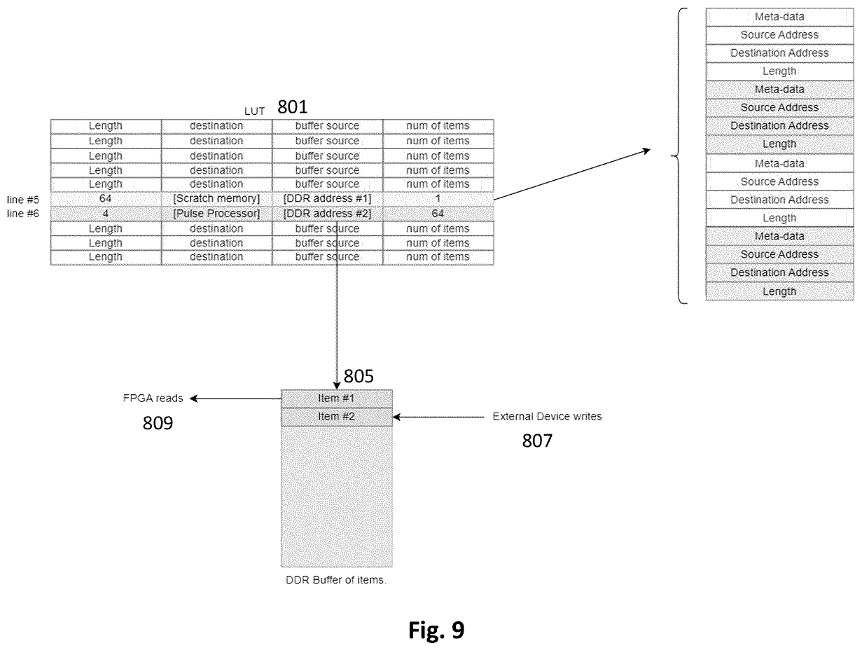

FIG. 8 illustrates an example of using an LUT for parametric programs, in accordance with various example implementations of this disclosure. The LUT 801 can be used not only for programs, but also for external data. A program may receive an input parameter 803 (in fact, the program is a function) which can be input from various sources, as described in reference to FIG. 2. With this method, a row in the LUT 801 may be added that will point to a location in the RAM that contains data to be copied to a specific address in the pulse processor memory. This enables a specific program's output to be pushed to another program's input without requiring any external software interaction, as depicted in FIG. 8. The user may add as many rows as necessary and toggle the parametric swap of variables strictly from hardware, and depending on the output of a previous program.

Since the pulse processors themselves can “activate” the processing of specific rows in the table, this method may be used to replace data while the program is running. For example, if the pulse processor memory does not have the capacity to contain more than one instance of a certain parameter, the data may be fetched/prefetched from an external database located on the RAM while the program is running. This allows a quantum controller to be implemented without being limited by its FPGA or ASIC resources, but rather uses a pseudo infinite memory. The pseudo infinite memory may expand the internal memory by a few orders of magnitude, greatly exceeding the amount of memory required to constantly drive a large set of qubits for large program iterations that are limited by the qubits lifetime. This enables the quantum controller more flexibility and capabilities when controlling the quantum processor.

FIG. 9 illustrates an example of using a look-up table to stream input items to running programs, in accordance with various example implementations of this disclosure. Another use-case of the LUT 801 is to stream parameters from an external device. The external device may be, for example, a high performance computer (HPC), a graphical processing unit (GPU) or a classical computer. Streaming parameters from an external device may allow the harvesting of tremendous compute power of a strong classical computer for the sake of complex classical computations required to compute the next program based on a set of historical programs.

Since this is done asynchronously from the quantum program, a cyclic buffer 805 may be used in the external RAM. In this example the ‘number of items’ column in the LUT is required to be larger than ‘1’, and the CI/PI is used. Whenever the external device “pushes” a parameter 807, it increases the PI (producer index). When the Program Loading hardware “pulls” the data 809, it increases the CI (consumer index). This method allows the rate of incoming/outgoing data to be monitored and prevents overflowing the buffer 805. Having the ability to pass parameters from a classical computer to a quantum processor while the program is running is an extremely important capability, allowing it to send and receive feedback from a classical computer to a quantum processor and vice versa, without stopping the quantum controller.

Since the pulse processor can ‘pull’ the data 809 from the buffer while the program is running, it can use the CI/PI mechanism to synchronously wait until PI>CI. This allows the realization of complicated program loading and execution graphs, which in quantum computing depends on various factors, and allows to pass data back and forth from the quantum controller and external devices, processors, or GPUs.

The system and methods described above may be used for multiple applications, including and not limited to: reducing a pre-compiled program execution time, loading a pre-compiled program with modified parameters, updated program data during execution and loading data from a memory extension during program execution.

The present method and/or system may be realized in hardware, software, or a combination of hardware and software and may consist of an individual system or computer, or a system comprised of multiple systems or computers (i.e. cloud computing and cloud storage service). The present methods and/or systems may be realized in a centralized fashion in at least one computing system, or in a distributed fashion where different elements are spread across several interconnected computing systems. Any kind of computing system or other apparatus adapted for carrying out the methods described herein is suited. A typical implementation may comprise one or more application specific integrated circuit (ASIC), one or more field programmable gate array (FPGA), and/or one or more processor (e.g., x86, x64, ARM, PIC, and/or any other suitable processor architecture) and associated supporting circuitry (e.g., storage, DRAM, FLASH, bus interface circuits, etc.). Each discrete ASIC, FPGA, Processor, or other circuit may be referred to as “chip,” and multiple such circuits may be referred to as a “chipset.” Another implementation may comprise a non-transitory machine-readable (e.g., computer readable) medium (e.g., FLASH drive, optical disk, magnetic storage disk, or the like) having stored thereon one or more lines of code that, when executed by a machine, cause the machine to perform processes as described in this disclosure. Another implementation may comprise a non-transitory machine-readable (e.g., computer readable) medium (e.g., FLASH drive, optical disk, magnetic storage disk, or the like) having stored thereon one or more lines of code that, when executed by a machine, cause the machine to be configured (e.g., to load software and/or firmware into its circuits) to operate as a system described in this disclosure.

As used herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As used herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As used herein, the term “exemplary” means serving as a non-limiting example, instance, or illustration. As used herein, the terms “e.g.,” and “for example” set off lists of one or more non-limiting examples, instances, or illustrations. As used herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.). As used herein, the term “based on” means “based at least in part on.” For example, “x based on y” means that “x” is based at least in part on “y” (and may also be based on z, for example).

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

What is claimed is:

1. A system comprising:
a pulse processor operable to produce a pulse according to a quantum program;
a pulse processor memory operable to store a plurality of elements of the quantum program;
a program loading component operable to load the plurality of elements of the quantum program from an external RAM; and
digital circuitry operable to execute a list of transactions associated with an operation of the program loading component; and
management software operable to preload the element of the quantum program into the local program database.

2. The system of claim 1, wherein the system comprises a look-up table operable to store a list of transactions associated with an operation of the program loading component.

3. The system of claim 1, wherein the quantum program is pre-compiled.

4. The system of claim 1, wherein:
the element of the quantum program is one of a plurality of program execution elements, and
the plurality of program execution elements comprises waveform data, instructions, commands and program variables data.

5. The system of claim 1, wherein the element of the quantum program is one of a plurality of scatter-gather descriptors.

6. The system of claim 1, wherein the element of the quantum program is a memory-copy routine.

7. The system of claim 6, wherein the memory-copy routine comprises a source address in the external RAM and a destination address in the pulse processor memory.

8. The system of claim 6, wherein the memory-copy routine comprises a transaction length and a transaction type.

9. The system of claim 1, wherein the element of the quantum program is a register-write routine.

10. The system of claim 9, wherein the register-write routine comprises a hardware register initialization sequence to be executed before the quantum program starts.

11. The system of claim 1, wherein the system comprises a plurality of pulse processors that are programmable in parallel.

12. The system of claim 1, wherein the system comprises a control unit configured to time an access to one or more of the digital circuitry, the pulse processor memory and the external memory.

13. The system of claim 1, wherein the system comprises a control unit configured to manage external requests to one or more of the digital circuitry, the pulse processor memory and the external memory.

14. The system of claim 1, wherein the quantum program is one of a plurality of programs that is scheduled with one or more parameters.

15. The system of claim 14, wherein the one or more parameters are acquired by a previous program of the plurality of programs according to a look-up table.

16. The system of claim 14, wherein the one or more parameters are streamed from an external device according to the digital circuitry, thereby harvesting compute power of the external device to generate a next program according to one or more historical programs.

17. The system of claim 14, wherein the one or more parameters are streamed before the quantum program executes.

18. The system of claim 14, wherein the one or more parameters are streamed while the quantum program is running.

19. The system of claim 14, wherein the one or more parameters are determined according to measurements performed by the quantum program.

20. The system of claim 14, wherein output from one or more programs, of the plurality of programs, is processed by an external processor and streamed back into the system.

21. The system of claim 14, wherein the one or more parameters are obtained from a static database.

22. The system of claim 1, wherein the external RAM is operable to extend the pulse processor memory accessible by the quantum program.

23. The system in claim 22, wherein the external RAM is operable to load one or more of waveform data, a pulse parameter and a quantum program instruction.

24. The system in claim 22, wherein data selected to be loaded from the external RAM is based on one or more results from the quantum program.

25. The system in claim 22, wherein the quantum program is executable while data is loaded from the external RAM.

26. The system of claim 1, wherein the system is a quantum controller.

27. The system of claim 2, wherein the look-up table is organized according to a graph.

28. The system of claim 2, wherein the look-up table is configured to calibrate a quantum processor.

29. The system of claim 1, wherein the stored list of transactions is operable to serve a scalable quantum computer without having to scale the digital circuitry.

30. The system of claim 1, wherein the quantum program pulls data from the local program database according to a consumer index maintained in a lookup table.

31. The system of claim 1, wherein the management software is operable to control an execution by the memory loading engine.

32. The system of claim 1, wherein a client device is operable to push data to the management software.

33. The system of claim 1, wherein the management software is operable to load a data item into the local program database.

34. The system of claim 1, wherein the management software is operable to maintain a producer index in the memory loading engine.

35. The system of claim 34, wherein the producer index is stored in a lookup table.

36. The system of claim 1, wherein the pulse processor memory is operable to pop a data item from the memory loading engine.

37. The system of claim 34, wherein the data item is stored in a lookup table.

38. The system of claim 1, wherein the management software is operable to load extended data memory into the local program database.

39. The system of claim 1, wherein the pulse processor memory is operable to request a data item from a lookup table.

40. The system of claim 1, wherein the management software is operable to indicate, to the memory loading engine, when data has been copied to the local program database.

41. The system of claim 1, wherein the indication comprises metadata.

42. The system of claim 41, wherein the metadata is maintained in a lookup table associated with the memory loading engine.

43. The system of claim 1, wherein the pulse processor memory is operable to update a parameter of the quantum program while the quantum program is running.

44. The system of claim 1, wherein the pulse processor memory is operable to update a parameter of the quantum program via a memory-copy routine.

45. The system of claim 1, wherein the pulse processor memory is operable to update a parameter of the quantum program via a register-copy routine.

46. The system of claim 1, wherein:
a client device is operable to stream data to the management software, and the data is calculated independently from previous results.

47. The system of claim 46, wherein the data is loaded according to one or more pulses.

48. The system of claim 46, wherein the data is loaded according to one or more parameters.
